(19) United States
(12) Patent Application Publication
(10) Pub. No.: US 2018/0305781 A1
(43) Pub. Date: Oct. 25, 2018

(54) Systems and Methods for Manufacturing High Strength Cladded Components

(71) Applicants: Andrew Hodgkinson, Spring, TX (US); Mandar Hingwe, Katy, TX (US); Rajeev Madazhy, Katy, TX (US)

(72) Inventors: Andrew Hodgkinson, Spring, TX (US); Mandar Hingwe, Katy, TX (US); Rajeev Madazhy, Katy, TX (US)

(73) Assignee: Federal Flange Inc., Houston, TX (US)

(21) Appl. No.: 15/494,729

(22) Filed: Apr. 24, 2017

(51) Int. Cl. C21D 9/00; C22C 38/48; C22C 38/46; C22C 38/44; C22C 38/42; C22C 38/06; C22C 38/04; C22C 38/02; C22C 38/00; C21D 8/00; C21D 6/00; C21D 1/60; B23K 31/02; B22D 25/02; C21D 1/18; B32B 15/01; B23P 6/00

(52) U.S. Cl. CPC C21D 9/0068; E21B 34/06; C22C 38/46; C22C 38/44; C22C 38/42; C22C 38/06; C22C 38/04; C22C 38/02; C22C 38/002; C22C 38/001; C21D 8/005; C21D 6/004; C21D 6/005; C21D 6/008; C21D 1/60; B23K 31/02; B22D 25/02; C21D 1/18; B32B 15/011; B23P 6/00; C22C 38/48

(57) ABSTRACT

Systems and methods for manufacturing high-strength cladded components such as pressure containing components that may be used in, e.g., oilfield systems to carry corrosive fluids at high pressures. Embodiments of the invention include products and processes in which low carbon HSLA Steel that has a yield strength greater than 70,000 psi is used as a base material from which a component is formed. A corrosion resistant alloy is welded to selected surfaces of the base metal. Because the base material has a low carbon content, welding the corrosion resistant alloy onto the base material does not create significant stresses in the base material and consequently eliminates the need for PWHT to relieve such stresses and eliminates strength degradation that normally results from PWHT. Eliminating PWHT also allows the component to be refurbished and re-cladded multiple times without significantly degrading the yield strength of the component.

### BACKGROUND

### Field of the Invention

The present invention relates generally to the field of mechanical manufacturing, and more particularly to cladded pressure containing component s and methods for manufacturing them. The pressure containing components use base materials which have compositions and heat treatments that provide increased strength and allow re-cladding without reducing the strength of the base material.

### Related Art

Oilfield components are used in equipment used to retrieve oil and natural gas. These components, used during the drilling and production of oil wells, are subject to erosion from abrasive slurries pumped during drilling and hydraulic fracturing, and corrosion from naturally occurring hydrogen sulfides and other chemicals released from the oil bearing formation during drilling and production activities. Due to the exposure of this damage, internal surfaces of these components are often cladded with corrosion resistant alloys such as stainless steel or nickel based alloys. Cladding is the bonding of two dissimilar metals usually performed by welding. The cladding material provides resistance to mechanical damage by being stronger than the base material of the component and more resistant than the base material to chemical damage (by being less chemically reactive).

While cladding a base material may provide the benefit of improved resistance to abrasion and corrosion, it has some disadvantages as well. For instance, applying the cladding material to the base material typically involves welding the cladding to the base material. The heat of welding can create stresses in the base material, which then need to be relieved by subsequent heat treatment. This heat treatment can reduce the strength of the base material or otherwise change the characteristics of the material. Over the life of the cladded component, the cladded surfaces may become worn and need replacement. It may therefore be necessary to remove the cladding material from the component, apply new cladding material, and machine the component to original part dimensions. The component may also require further post-cladding heat treatment, which will relieve stresses induced by the welding of the new cladding material, but will also degrade the characteristics of the base material.

### SUMMARY OF THE INVENTION

This disclosure is directed to systems and methods for manufacturing components such as pressure containing components that are used in oilfield systems to carry corrosive fluids at high pressures. Embodiments of the invention include products and processes in which low carbon HSLA Steel that has a yield strength greater than 70,000 psi is used as a base material from which a component is formed, then a corrosion resistant alloy is welded to selected surfaces of the base metal. Because the base material has a low carbon content, welding the corrosion resistant alloy onto the base material does not create significant stresses in the base material and consequently does not require PWHT to relieve such stresses before the component is installed in the system in which it will be used. Additionally, the component can be refurbished and re-cladded multiple times without the strength degradation that results from PWHT.

Numerous other embodiments are also possible.

### BRIEF DESCRIPTION OF THE DRAWINGS

Other objects and advantages of the invention may become apparent upon reading the following detailed description and upon reference to the accompanying drawings.

FIG. 1 is a diagram illustrating a cross-section of a portion of a cladded component.

FIG. 2 is a flow diagram illustrating a simplified method in accordance with one embodiment.

FIG. 3 is a flow diagram illustrating a more detailed method for forming an oilfield component in accordance with one embodiment.

FIG. 4 is a diagram illustrating an exemplary oilfield system component in accordance with one embodiment.

FIG. 5 is a flow diagram illustrating a method for refurbishing an oilfield component in accordance with one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims. Further, the drawings may not be to scale, and may exaggerate one or more components in order to facilitate an understanding of the various features described herein.

### DETAILED DESCRIPTION OF EXEMPLARY EMBODIMENTS

One or more embodiments of the invention are described below. It should be noted that these and any other embodiments described below are exemplary and are intended to be illustrative of the invention rather than limiting.

As described herein, various embodiments of the invention comprise products and methods in which components of oilfield equipment are formed from high strength low alloy steel base material having specific chemical compositions, undergo specific heat treatment, and have one or more surfaces cladded with corrosion resistant and abrasion resistant material, wherein the cladding does not create significant stresses in the base material and no post-weld heat treatment is necessary after the cladding is applied.

Carbon Steel is a known base material. Carbon Steel is characterized in forged oilfield components as being defined by American Society for Testing and Materials (ASTM) standards A-105N or A350 LF2. Every steel is some type of alloy with iron. “Low alloy steel” is a standard term referring to steel containing various alloying elements. It is further categorized as Low Carbon, Medium Carbon, High Carbon, and Ultrahigh carbon, based on the carbon content by weight of the steel.

High Strength Low Alloy (HSLA) Steel is a type of Carbon Steel which is a known base material. HSLA Steel as used in forged oilfield components is defined by ASTM specifications A694 or A707. HSLA Steel is characterized by a carbon content of 0.05%-0.25% by weight. For oilfield pressure-containing components. Conventional HSLA Steel is known to range in yield strength from 35,000 psi to 70,000 psi, and have a carbon content of 0.05%-0.11% by weight. U.S. Pat. No. 3,139,511, issued to Kudelko on Jun. 30, 1964, teaches HSLA low carbon steel as the base material of a component that can be clad with a corrosion resistant alloy. U.S. Pat. No. 3,885,922, issued to Thomas, Jr., et al on May 27, 1975, also discloses HSLA low carbon steel as the base material of a component that is clad with a corrosion resistant lining.

Medium Carbon Low Alloy (MCLA) steel is another known Carbon Steel that can be used as a base material for oilfield components. MCLA Steel is characterized in forged oilfield components as being defined by American Iron and Steel Institute (AISI) specifications A4XXX (where “XXX” identifies a particular variant of MCLA Steel). Compared to Carbon Steel, MCLA steels have improved strength, toughness, hardness, and corrosion resistance. The carbon content for MCLA Steel is known to range from 0.25%-0.60%. For oilfield components, MCLA Steel is known to range in yield strength to at least 75K psi, and has a carbon content of 0.28%-0.35% by weight.

Base materials such as Carbon Steel, HSLA Steel and MCLA Steel require heat treatment in order to achieve the strength and various other characteristics that are necessary for the materials to be suitable for use in such products as oilfield components. Generally, heat treatment involves heating and cooling for the specific purpose altering mechanical properties of the steel. Because heat treatment is necessary to achieve the desired characteristics, industry standards typically define the specific heat treatment processes that are required for the different types of steel. The heat treatment processes that are applied to materials used for the manufacturing of oilfield components commonly include steps such as Normalizing, Austenitizing, Quenching and Tempering, and Precipitation Hardening.

As noted above, the base materials of oilfield components are sometimes clad with corrosion resistant alloys to reduce erosion from abrasive slurries and corrosion from hydrogen sulfides or other chemicals. Cladding is a known process. Various patents and publications which describe cladding of oilfield components are available. For example, U.S. Pat. No. 4,026,583, issued to Gottlieb on May 31, 1977, teaches the background of the overall cladding process. Cladding materials are known to include such materials as Nickel based alloys (e.g., Hastelloy™, Inconel™ 625, MP35N™), and stainless steel grades such as 316. U.S. Pat. No. 4,533,806, issued to Kawasaki et al on Aug. 6, 1985, discloses a steel tube with cladding of Inconel™ 625 for use as an oilfield component.

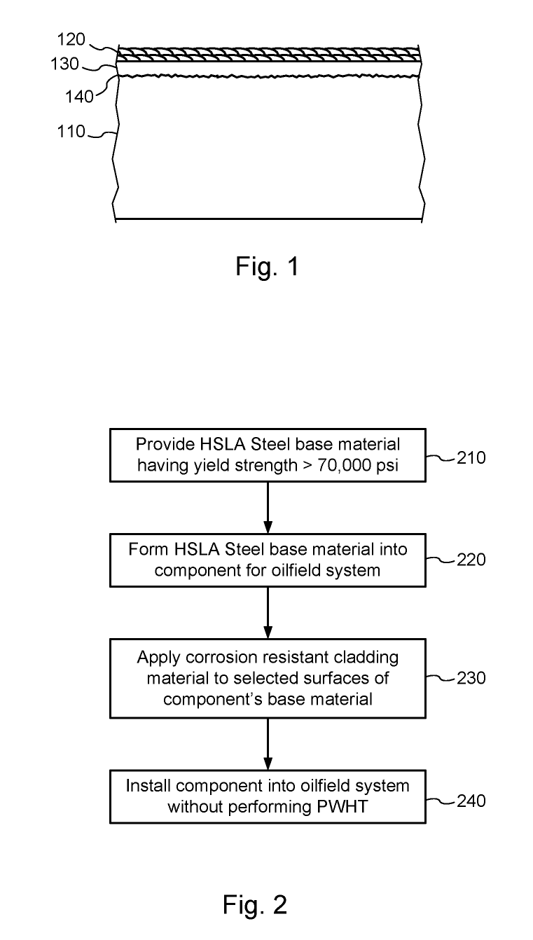

The technology of cladding has advanced by specifying the chemical composition of the cladding material and the patterns of selective cladding on the base material. Regardless of the composition of the cladding material, however, when cladding is applied to a base material of MCLA Steel, the heat of welding the cladding material to the base material affects the MCLA Steel. More specifically, an area of the base material adjacent to the cladding region (known as the Heat Affected Zone, or HAZ) develops micro-hardness greater than Rc 22 and, upon cooling to room temperature, this region has stresses induced in it. This is illustrated in FIG. 1, which depicts a cross-section of a portion of a cladded component. In this figure, the MCLA Steel base material 10 has a cladding material 20 which has been welded to the surface of the base material. The heat of welding creates stresses in HAZ 30, which may result in cracks 40. In order to lower the micro-hardness below Rc 22 in compliance to NACE MR0175, and to relieve the induced stresses in the HAZ, the component is subjected to a Post Weld Heat Treat (PWHT) cycle. The PWHT cycle typically consists of heating the product to a temperature of 50° F. below the final tempering temperature for the base material and holding this temperature for a certain duration which is defined in the Weld Procedure Specification (WPS) for the material. It should be noted that tempering of compositions with higher levels of copper may result in precipitation hardening, and this type of tempering is typically referred to as aging.

While PWHT relieves stresses induced in the HAZ by welding the cladding onto the base material, PWHT can also reduce the functional strength of the MCLA Steel component. This may occur in two ways: the PWHT temperature may encroach on the temperature used to temper the base material; or the PWHT may be performed for a number of cycles which is greater than the allowable number of PWHT cycles as defined by the approved WPS. In either case, the strength of the component may be compromised, so the component must be replaced.

Successive repair cycles including PWHT of components manufactured using MCLA steel results in degradation of the mechanical properties of the base material to the point that they could be lowered below the original design specification. This incurs a field risk, in that the potential for a component failure becomes greatly increased due to the unknown degraded yield strength of the base material. It is common practice when forging components from a batch of a particular base material to subject a test coupon of the material to one or more secondary tempering cycles, known as a Simulated Post Weld Heat Treatment (SPWHT) in order to determine the reduction in mechanical properties of the base material after it has been cladded and undergone PWHT for a specified number of cycles. When cladding the component itself, even if the PWHT does not weaken the component enough to require replacement, the PWHT cycle incurs costs because it causes downtime due to cycle preparation and actual PWHT time.

The process of cladding HSLA Steel is very similar to the process of cladding MCLA Steel, with the exception of the PWHT process. Since HSLA Steel has a lower carbon content than MCLA Steel, the micro-hardness of the HSLA Steel remains lower than Rc 22.0 after the cladding is welded onto it, and residual stresses in the HSLA Steel resulting from the cladding process are minimal. Therefore, a PWHT cycle is usually unnecessary. Since no PWHT cycle is performed, the strength and other characteristics of the HSLA Steel are not degraded like those of MCLA Steel, which must undergo PWHT. In the case of a component using HSLA Steel as a base material, the cladding from the base material can simply be machined out and re-cladded. This process can be repeated multiple times, as there is no PWHT cycle to degrade the material. As a result, HSLA Steel provides a base material for components that can be refurbished as needed without degrading material characteristics such as yield strength.

Although HSLA Steel provides the benefit of allowing components to be refurbished without employing PWHT cycles and thereby degrading the base material, it has some disadvantages of its own. As noted above, HSLA Steels have yield strengths that range from 35,000 psi to 70,000 psi. It is not uncommon, however, for oilfield components to require yield strengths in excess of 70,000 psi. Because the yield strength of conventional HSLA Steel does not exceed 70,000 psi, it normally is not considered for use in these components. Instead, MCLA Steel, which can achieve yield strengths greater than 70,000 psi using conventional technologies, is used to make these components. Further, because the metallurgy of HSLA Steel is more complicated than that of MCLA Steel, it is generally considered to be more costly to develop and more difficult to produce with adequate consistency. Consequently, conventional wisdom has dictated that high-pressure oilfield components (those requiring base material yield strengths greater than 70,000 psi) be made of MCLA Steel, even though they are subject to degradation of yield strength as a result of PWHT.

Because of the drawbacks of using conventional MCLA and HSLA steels in high pressure oilfield components, it would be desirable to be able to manufacture these components with base materials that have: high yield strength which was previously only achievable by MCLA Steel; and the ability to clad the base material without requiring PWHT which was previously only achievable by HSLA Steel. More specifically, it would be desirable to provide a base material of HSLA Steel that achieves a mechanical yield strength greater than 70,000 psi. Further, it would be desirable to provide a base material that maintains a yield strength exceeding 70,000 psi after cladding. Still further, it would be desirable to provide a base material that maintains a yield strength exceeding 70,000 psi and does not require post weld heat treatment after cladding.

The embodiments of the invention described herein include, for example, HSLA Steel compositions and heat treatments and oilfield components (e.g., pressure containing components) that are formed using HSLA Steel base materials with cladding on one or more of the component surfaces, where the HSLA Steel has a particular combination of chemical composition and heat treatment that achieves a yield strength of greater than 70,000 psi and does not require PWHT after the cladding is welded to the cladded surfaces of the base material. Other embodiments include processes for manufacturing the HSLA Steel base material, for manufacturing oilfield components using the HSLA Steel, and refurbishing the manufactured components without undergoing PWHT.

Referring to FIG. 2, a flow diagram illustrating a simplified method in accordance with one embodiment is shown. In this method, a base material is first provided (210), where the base material is an HSLA Steel that has a yield strength greater than 70,000 psi. Examples of such a base material are provided below. The base material is formed into a high-pressure component for an oilfield system (220). The component may be, for example, a valve body or other type of pressure containing component, and may be manufactured using conventional forging techniques. Cladding is then applied to one or more of the component's surface (230) by, for instance, welding the cladding material to the base material. The cladded component is then installed in the oilfield system without applying PWHT to the component (240).

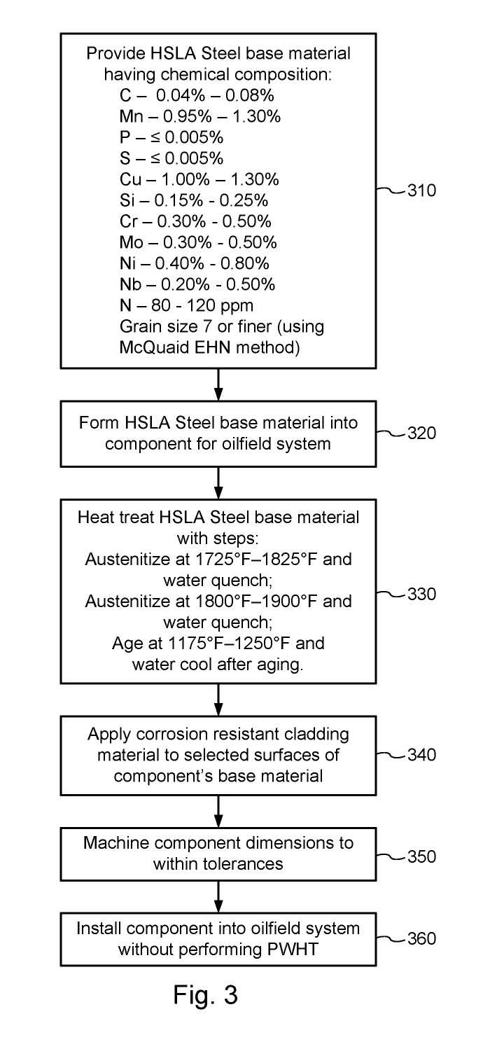

Referring to FIG. 3, a flow diagram illustrating a more detailed method for forming an oilfield component is shown. In this embodiment, a base material having the following chemical composition is provided (310):

C - 0.04%-0.08%;
Mn - 0.95%-1.30%;
P - ≤0.005%;
S - ≤0.005%;
Cu - 1.00%-1.30%;
Si - 0.15%-0.25%;
Cr - 0.30%-0.50%;
Mo - 0.30%-0.50%;
Ni - 0.40%-0.80%;
Nb - 0.20%-0.50%;
N - 80-120 PPM;
Grain Size - ASTM 7 or finer using McQuaid Ehn method.

This base material is formed into a high-pressure component for an oilfield system (320). After the component is formed, it undergoes a heat treatment process that comprises the following steps (330):

Austenite at 1725° F.-1825° F. and water quench;
Austenitize at 1800° F.-1900° F. and water quench;
Age at 1175° F.-1250° F.;
Water cool after Aging.

It should be noted that the specific times for each of these steps will vary, depending upon the size of the component being manufactured. The larger the components is, the longer the time required for each step will be, since it takes longer for the temperature to propagate through the component.

After the component has undergone this heat treatment process, the HSLA Steel base material achieves its final characteristics, including reaching a yield strength of greater than 70,000 psi. Cladding material is then applied (340) to selected surfaces of the component which, in operation, will be in contact with abrasive and/or corrosive fluids. The cladding is applied by welding the cladding material to the base material. As noted above, because the HSLA Steel base material has a low carbon content, the heat of welding does not create a HAZ in which stresses are induced. Because there are no significant stresses in the base material, the component does not require PWHT (which is required to relieve induced stresses in MCLA Steel base materials), and the component is ready to install in an oilfield system. The cladded surface(s) of the component may be machined (350) if necessary to bring the cladded surfaces within specified tolerances of the component's design dimensions. The cladded component is then installed in the oilfield system (360).

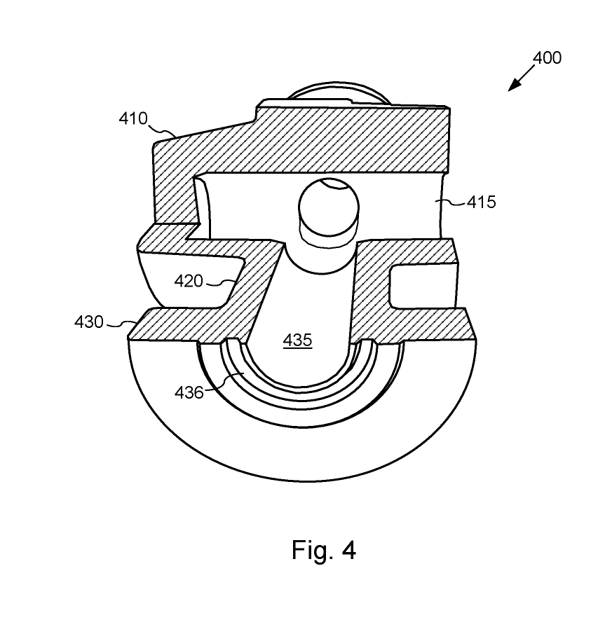

Referring to FIG. 4, an exemplary oilfield system component in accordance with one embodiment is shown. This component is merely an example of the types of components that may be formed in accordance with the invention. In this embodiment, the component is a valve body 400. Valve body 400 is used to control the flow of abrasive/corrosive fluids through the body at high pressures. For purposes of clarity, the valve mechanism that would be installed within the valve body in the completed valve is not shown. Valve body 400 has a cylindrical barrel 410 with a cylindrical neck 420 that extends outward from the barrel to form a fluid port 425. A flange 430 is provided at the end of neck 420 to allow fluid port 425 to be coupled to another system component (e.g., pipe section, manifold, etc.) A second cylindrical neck extends from barrel 410 opposite neck 420 to allow installation of the valve mechanism to be installed in body 400.

Valve body 400 is formed using an HSLA Steel base material. The HSLA Steel may have various compositions, such as those described herein. The valve body may be formed by forging, casting, machining or any other suitable technique. After the valve body is formed, it is heat treated to achieve the desired characteristics (e.g., yield strength). The specific combinations of chemical composition and heat treatment disclosed herein provide yield strengths of greater than 70,000 psi. After the valve body has undergone the prescribed heat treatment, selected surfaces of the valve body are cladded with a layer of a corrosion resistant alloy in order to provide increased corrosion resistance in comparison to the base material. In the embodiment of FIG. 4, the interior surface 415 of barrel 410 is cladded with the corrosion resistant alloy. Fluid port 425 and portions of the face 435 of flange 430, such as ring groove 436 may also be cladded. The corrosion resistant alloy cladding is welded to the selected surfaces. Because the base material is an HSLA Steel which has a low carbon content, the welding of the corrosion resistant alloy does not create significant stresses in the base material, and it is not necessary to perform any PWHT on the valve body to reduce such stresses. The valve body is there ready to be assembled with the remaining elements of the valve and installed in the larger oilfield system for which it was designed. This contrasts the case of MCLA Steel base materials, which requires PWHT to reduce stresses caused by welding the cladding onto the base material, and which typically suffer degraded strength as a result of the PWHT.

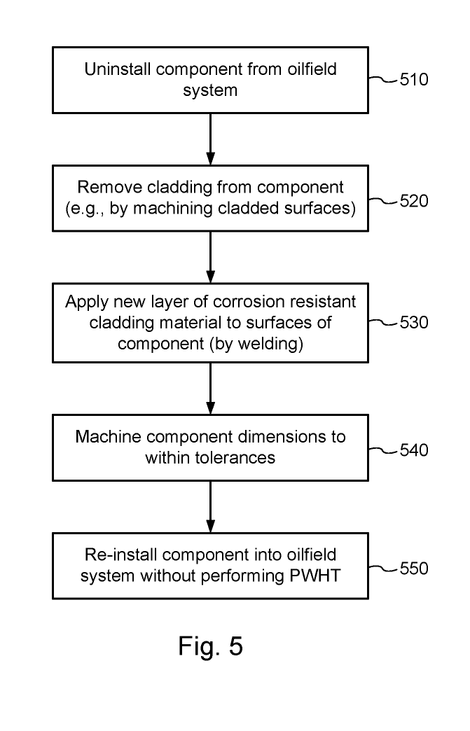

As described above in connection with FIG. 3, one embodiment is a method for manufacturing a component for an oilfield system. One alternative embodiment is a method for refurbishing a component of the type manufactured by the method of FIG. 3. This method is illustrated in the flow diagram of FIG. 5. As shown in this figure, a component of an oilfield system is first uninstalled from the system (510). The component has an HSLA Steel base material that has been cladded with a corrosion resistant cladding material, but has not undergone PWHT. After the component is removed from the system, the cladding material is removed from the base material (520). This typically involves machining the component to remove the cladding material (some of which may have already eroded away) and expose the underlying base material. The exposed, previously cladded surface of the base material is then re-cladded by welding a layer of cladding material onto the surface (530). This cladding step may be the same as the cladding step (340) in the method of FIG. 3. As in the earlier method, the low carbon content of the HSLA Steel base material prevents significant stresses from being induced in the base material. The cladded surfaces of the component are then machined (540) if necessary to bring the cladded surfaces into required dimensional tolerances for the component. Because no significant stresses are created in the HSLA Steel base material, the component is re-installed in the oilfield system (550) without undergoing any PWHT.

It should be noted that there may be alternative combinations of chemical composition based on the Carbon Equivalent (CE) limitations and heat treatment that produce an HSLA Steel base material that has the required yield strength of greater than 70,000 psi. For example, in one alternative embodiment, the HSLA Steel may have the following chemical composition:

C - 0.07%-0.14%;
Mn - 0.75%-0.85%;
P - ≤0.005%;
S - ≤0.005%;
Cu - ≤0.20%;
Si - 0.15%-0.25%;
Ni - 0.30%-0.60%;
Cr - 0.30%-0.50%;
Mo - 0.30%-0.40%;
V - 0.04%-0.08%;
Nb - 0.03%-0.06%;
Al - 0.02%-0.04%;
N- 80-120 PPM;
Grain Size - ASTM 7 or finer using McQuaid Ehn method;
Carbon Equivalent (CE) - Less than 0.45.

This base material then undergoes a heat treatment process that comprises the following steps:

Austenitize at 1725° F.-1825° F. and water quench;
Austenitize at 1750° F.- 1850° F. and water quench;
Temper at 1175° F.-1250° F.;
Water cool after Tempering.

As with the embodiments described above, the amount of time required for each step in the heat treatment process will be dependent upon the size of the component undergoing the heat treatment.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A product comprising:
a pressure containing component having a body formed of a base material;
wherein the base material is a high strength low alloy steel having a carbon content of between 0.05% and 0.11% by weight and has a yield strength greater than 70,000 psi;
wherein the body has one or more interior surfaces which have a corrosion-resistant and abrasion-resistant cladding material welded thereon;
wherein the body is non-post-weld-heat-treated.

2. The product of claim 1, wherein the base material has a chemical composition including, by weight, 0.04%-0.08% C; 0.95%-1.30% Mn; ≤0.005% P; ≤0.005% S; 1.00%-1.30% Cu; 0.15%-0.25% Si; 0.30%-0.50% Cr; 0.30%-0.50% Mo; 0.40%-0.80% Ni; and 0.20%-0.50% Nb; 80-120 ppm N; and has a grain size of ASTM 7 or finer using the McQuaid Ehn method.

3. The product of claim 2, wherein the base material has been heat treated by a process including the steps: Austenitizing a first time at 1725° F.-1825° F. and water quenching; Austenitizing a second time at 1800° F.-1900° F. and water quenching; and Aging at 1175° F.-1225° F. followed by water cooling.

4. The product of claim 1, wherein the base material has a chemical composition including, by weight, 0.07%-0.14% C; −0.75%-0.85% Mn; ≤0.005% P; ≤0.005% S; ≤0.20% Cu; −0.15%-0.25% SI; 0.30%-0.50% Cr; 0.30%-0.40% Mo; 0.30%-0.60% Ni; 0.04%-0.08% V; 0.03%-0.06% Nb; and 0.02%-0.04% Al; 80-120 ppm N; wherein the base material has a grain size of ASTM 7 or finer using the McQuaid Ehn method and has a carbon equivalent (CE) of less than 0.45.

5. The product of claim 4, wherein the base material has been heat treated by a process including the steps: Austenitizing a first time at 1725° F.-1825° F. and water quenching; Austenitizing a second time at 1750° F.-1825° F. and water quenching; and tempering at 1175° F.-1225° F. followed by water cooling.

6. The product of claim 1, wherein the pressure containing component has been formed by hot forging.

7. The product of claim 1, wherein the pressure containing component has been formed by investment casting.

8. The product of claim 1, wherein the pressure containing component has been formed by machining.

9. A process comprising:
providing a base material which is a high strength low alloy steel having a carbon content of between 0.05% and 0.14% by weight;
forming a pressure containing component with the base material;
heat treating the base material and thereby increasing a yield strength of the base material to greater than 70,000 psi;
welding a corrosion-resistant and abrasion-resistant cladding material to one or more interior surfaces of the pressure containing component; and
installing the pressure containing component in an oilfield system without post-weld heat treatment.

10. The process of claim 9, wherein the base material has a chemical composition including, by weight, 0.04%-0.08% C; 0.95%-1.30% Mn; ≤0.005% P; ≤0.005% S; 1.00%-1.30% Cu; 0.15%-0.25% SI; 0.30%-0.50% Cr; 0.30%-0.50% Mo; 0.40%-0.80% Ni; and 0.20%-0.50% Nb; 80-120 ppm N; and has a grain size of ASTM 7 or finer using the McQuaid Ehn method.

11. The process of claim 10, wherein the base material has been heat treated by a process including the steps: Austenitizing a first time at 1725° F.-1825° F. and water quenching; Austenitizing a second time at 1800° F.-1900° F. and water quenching; and aging at 1175° F.-1250° F. followed by water cooling.

12. The process of claim 9, wherein the base material has a chemical composition including, by weight, 0.07%-0.14% C; −0.75%-0.85% Mn; ≤0.005% P; ≤0.005% S; ≤0.20% Cu; −0.15%-0.25% SI; 0.30%-0.50% Cr; 0.30%-0.40% Mo; 0.30%-0.60% Ni; 0.04%-0.08% V; 0.03%-0.06% Nb; and 0.02%-0.04% Al; 80-120 ppm N; wherein the base material has a grain size of ASTM 7 or finer using the McQuaid Ehn method and has a carbon equivalent (CE) of less than 0.45.

13. The process of claim 12, wherein the base material has been heat treated by a process including the steps: Austenitizing a first time at 1725° F.-1825° F. and water quenching; Austenitizing a second time at 1750° F.-1850° F. and water quenching; and aging at 1175° F.-1250° F. followed by water cooling.

14. The process of claim 9, further comprising uninstalling the pressure containing component from the oilfield system, remove the cladding material from the pressure containing component, welding replacement cladding material to the one or more interior surfaces of the pressure containing component, and reinstalling the pressure containing component in the oilfield system without post-weld heat treatment, wherein the base material of the pressure containing component maintains the yield strength greater than 70,000 psi.

15. The process of claim 14, wherein remove the cladding material from the pressure containing component comprises machining the cladding material.

16. The process of claim 14, further comprising, prior to reinstalling the pressure containing component in the oilfield system, machining the replacement cladding and thereby bringing one or more dimensions of the pressure containing component into corresponding tolerances.

17. The process of claim 14, wherein the yield strength of the base material after welding the replacement cladding material to the one or more interior surfaces of the pressure containing component is within 4% of the yield strength of the base material prior to welding the replacement cladding material to the one or more interior surfaces of the pressure containing component.
